(19) United States
(12) Patent Application Publication
(10) Pub. No.: US 2014/0359703 A1
(43) Pub. Date: Dec. 4, 2014

(54) METHOD FOR SECURING AN ACTION THAT AN ACTUATING DEVICE MUST CARRY OUT AT THE REQUEST OF A USER

(71) Applicants: Alan Paul Marston Nicholson, Asnieres (FR); Charles Tuil, Boulogne sur Seine (FR)

(72) Inventors: Alan Paul Marston Nicholson, Asnieres (FR); Charles Tuil, Boulogne sur Seine (FR)

(73) Assignee: Genmsecure, Paris (FR)

(21) Appl. No.: 14/344,082

(22) PCT Filed: Jun. 5, 2012
(86) PCT No.: PCT/FR2012/051247

§ 371 Date: Jul. 14, 2014

(30) Foreign Application Priority Data
Jun. 8, 2011 (FR) 1155011

(51) Int. Cl. H04W 12/06

(52) U.S. Cl. CPC H04W 12/06
USPC 726/3

(57) ABSTRACT

A method for securing an action that an actuating device must carry out at the request of a user. In the method, before any request by the user for an action, an identification link and a user authentication link are set up and registered on the security server via a dialog among the security server, the actuating device, and the user acting via a portable terminal. The invention can be used in the field of bank transactions.

### FIELD OF THE INVENTION

The invention relates to a method for securing an action that an actuating device must carry out at the request of a user, under the control of a security server, by means of a portable terminal such as a mobile telephone belonging to the user.

### BACKGROUND

Methods of this type, which are known, have the drawback that they only provide partial securing inasmuch as they do not involve verifying whether the mobile telephone is in the hands of its true owner.

The invention aims to offset this drawback.

### SUMMARY OF THE INVENTION

To achieve this aim, the method according to the invention is characterized by the establishment and registration, with the security server, prior to any request for action by the user, of an identification link and a user authentication link, through a dialogue between the security server, the actuating device and the user acting through his portable terminal.

According to one feature of the invention, the method is characterized in that the user identification link is formed by the association of identification data provided to the security server by the actuating device and the number of the user's portable terminal.

According to another feature of the invention, the method is characterized in that the user authentication link is based on confidential data attached to the user's person and associated with the data of the latter's identification link.

According to still another feature of the invention, the method is characterized in that the aforementioned confidential data resides in a password created by the user and communicated by the latter to the security server.

According to still another feature of the invention, the method is characterized in that, to register the user identification link with the security server, the actuating device provides the security server with the user's identification data, the server returns a message to the actuating device designating the registration, which that device sends to the user, who sends it back to the security server by SMS message, through which the server learns the number of the user's portable terminal.

According to still another feature of the invention, the method is characterized in that the verification of the identity and authenticity of the requester, when the latter asks the actuating device to perform an action, take place in the form of a dialogue between the security server, the actuating device and the user acting through his portable terminal.

According to still another feature of the invention, the method is characterized in that, to allow the user identification and authentication dialog, when an action is requested, the security server downloads, into the user's portable terminal during registration of the identification and authentication links, a program of the Applet type that includes the software and data necessary for the user identification and authentication dialog.

According to still another feature of the invention, the method is characterized in that the user identification and authentication dialog, when the latter submits a request for an action from the actuating device, involves the actuating device sending the user's identification data the security server and indicating the nature of the request; the server sending the user's portable terminal data indicating the nature of the requested action; and the user using his portable terminal to send confidential authentication data to the security server, which authorizes the actuating device to perform the requested action if it recognizes that the received confidential data complies with the recorded confidential data.

### BRIEF DESCRIPTION OF DRAWING FIGURES

The invention will be better understood, and other aims, features, details and advantages thereof will appear more clearly, in the following explanatory description done in reference to the appended drawings, provided solely as an example illustrating several embodiments of the invention and in which:

FIG. 1 is a block diagram illustrating the process for establishing and securing the user identification and authentication link;

FIG. 2 is a block diagram illustrating the process for verifying the authenticity of the user before an action is performed by an actuating device, in the field of banking transactions;

FIGS. 3 and 4 are block diagrams of two other applications of the invention.

### DETAILED DESCRIPTION

The invention generally applies to all applications in which a user asks an actuating device to perform an action to his benefit, which is secured by a security server.

Below, as non-limiting examples, three applications of the method according to the invention will be described.

FIG. 1 illustrates the first phase of the method according to the invention, i.e., the process for registering the user UT of the services of an actuating device DA, with a security server SS, in the field of banking transactions. In the illustrated example, the registration process is initiated by a request from the user UT, symbolized by arrow 1. In step 2, the actuating device DA, for example a bank branch, sends the security server SS the user's banking information, such as his bank account or debit card information.

After the registration request is received, in step 3, the security server uses the branch channel to send an OTP (one-time password) message to the actuating device DA. In step 4, the latter device sends the OTP to the user UT, more specifically to his portable terminal TP, for example a mobile telephone. In step 5, the user in turn uses his mobile telephone TP to send the OTP back to the security service in an SMS (short message service) message. Once the security server receives the SMS, it then learns the user's mobile telephone number and establishes the link between the banking information identifying the user and the mobile telephone number.

Then, in step 6, the security server addresses the mobile telephone and downloads a program thereon of the type known under the name Applet, which contains software making it possible to later perform user authentication processes, and the data necessary to implement that process. The user next creates a password, which he sends to the security service in step 7, which is then able to register, after the identification link linking the mobile telephone to the user's banking information, an authentication link that uses the password to link the user's person to the data already recorded with the security service. The registration process ends with the establishment of the authentication link.

The establishment of this link has just been described, as an example, in the application of the invention to the banking field, but this process takes place similarly in other application fields. It always involves, after downloading the Applet into the mobile telephone, having the user use the mobile telephone to send a password that he has created and is known only to him.

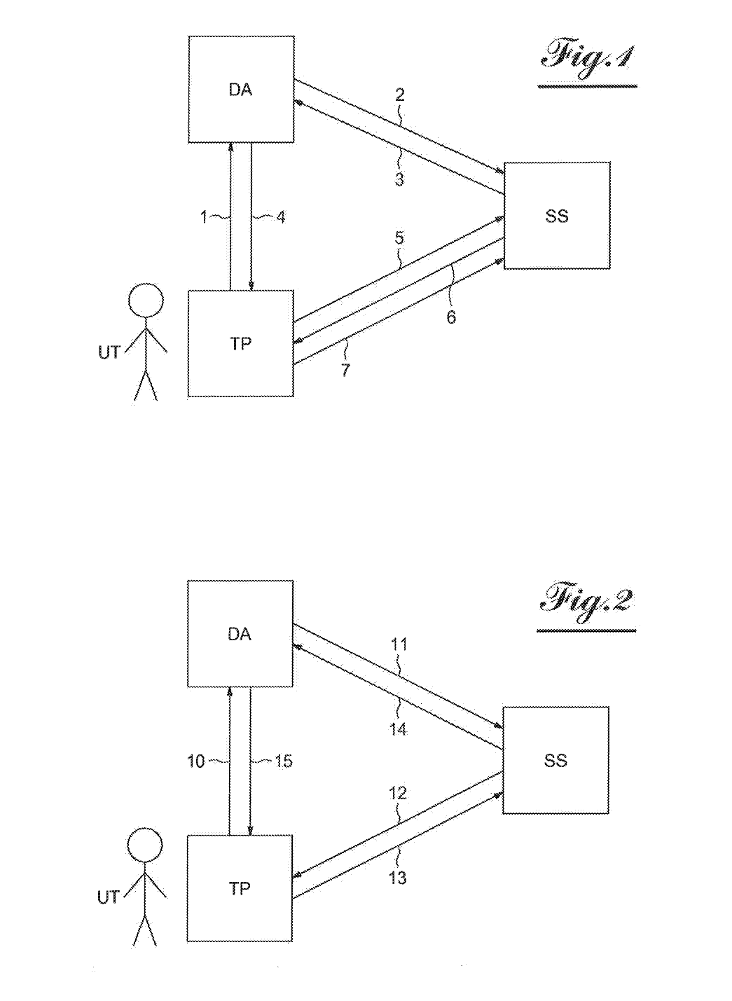

In reference to FIG. 2, the second phase of the method according to the invention will be described below, namely the process during which, still in the example of the banking field, the user asks a bank branch to perform a banking transaction. For example, the user asks the actuating device DA to withdraw 500 euros in cash, which requires access to his bank account. This initial step of the process is indicated by reference 10 in FIG. 2. In step 11, the device DA sends the security server SS a message containing the user's banking information and the reason, i.e., the indication of the operation of which performance is requested, namely the withdrawal of an amount of 500 euros. In the following step 13, the server SS sends the user's mobile telephone TP a message displaying the reason for the requested transaction, i.e., the withdrawal of an amount of 500 euros, on the display screen of the telephone. After reading the message, the user responds to the security service by sending his password that he had created during the registration process with the security service. This step for sending the password is referenced 13.

The security server SS is therefore capable of authenticating the user by comparing the password it has just received with the password stored during the registration phase and associated with the banking information and mobile telephone number. If the received password matches the registered password, in step 14 the server indicates its agreement to the actuating device, namely the bank branch, and in step 15 the latter delivers the amount requested by the user.

The description provided above shows that the invention ensures the authentication of the user, i.e., verifies that the person benefiting from transaction is indeed the authorized user, owing to the password only known by the latter, since he is the one who created it.

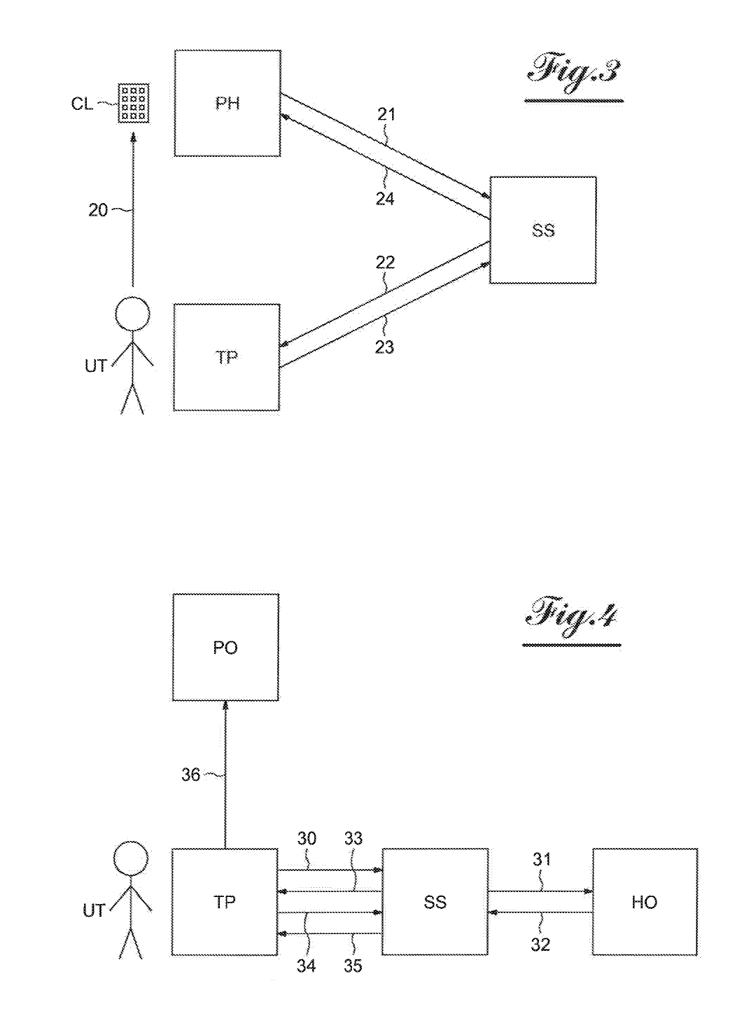

In reference to FIG. 3, we will describe another application of the method according to the invention, which nevertheless progresses using the same rules as the application described above. In the example of FIG. 3, the user is requesting the opening of the door PH of a hotel room that he has reserved. The door opening is done securely under the control of a security server SS. It should be noted that, during the registration process, the security server SS had recorded the link between a user identification code, and the user's mobile telephone number and password. To initiate the process of opening the door, the user types on the hotel keyboard CL without an identification code in step 20, which causes the security service SS to send a message in step 21 containing the identification code and the reason, i.e., the request to open the door. In accordance with the example of FIG. 2, in step 22, the server SS sends the user's mobile telephone TP a message containing the reason. After reading that reason, the user sends his password in step 23. After recognizing the compliance between the received password and the password initially registered, the server indicates its agreement to the actuating device DA in step 24, which causes the hotel room door to be opened in accordance with the user's request.

It will be noted that this opening only occurs after authentication of the user, i.e., the recognition that it is indeed that user who is authorized to request opening of the door.

FIG. 4 illustrates another example embodiment of the method according to the invention in the hotel application. In this case, the mobile telephone TP is programmed to send a request to open the door of the room that the user has reserved directly to the security server SS in step 30. After receipt of the request, in step 31 this server addresses the hotel HO so that the latter can confirm the user's reservation. In step 33, the server SS sends the mobile telephone TP the message containing the reason for the request, which is then displayed on the screen of the telephone, after which the user sends his password to the server in step 34. After compliance between the received password and the initially registered password has been recognized, in step 35 the server sends the user a temporary code allowing the user to command the opening of the door in step 36, for example using his telephone, which is then provided with means, either wireless or using any other suitable method, for transmitting a signal to the door mechanism then equipped with a receiver antenna, which causes the door to open.

As shown by the preceding description of the invention, the user authentication dialogue takes place between the latter and the security server, which constitutes a considerable advantage of the security method proposed by the invention. In fact, the confidential data is, as of entry by the user on the portable terminal, transmitted by the latter directly to the security server, without passing through channels that could allow third parties to pick up confidential information. Thus, the invention guarantees the confidentiality of the data with regard to any ill-intentioned third parties.

Given that during the identification dialogue, the user enters confidential data on his own portable terminal, the invention is therefore usable for any type of actuating device, including actuating devices not allowing such information to be entered.

To further increase the security level of the authentication system, the communication link between the user's portable terminal and the security server may be encrypted in order to prohibit any misappropriation of the confidential data when it passes over the communication network.

To allow a still higher level of security, the encryption may be dynamic, linking the dialogue phases to each other, in order to prevent the reintroduction of earlier exchanges into the network to try to trick the security server.

1. A method for securing an action that an actuating device must carry out at the request of a user, under the control of a security server, via a portable terminal having a number, the method comprising:
establishing and registering, with the security server, prior to any request for action by the user, an identification link and a user authentication link, and
communicating by the user the identification link and the user authentication link, to the security server,. during a prior registration of the user with the security server.

2. The method according to claim 1, including forming the user identification link by associating user identification data provided to the security server by the actuating device and the number of the portable terminal.

3. The method according to claim 1, wherein that the user authentication link is based on confidential data attached to the user and associated with the data of the user identification link.

4. The method according to claim 3, wherein the confidential data includes a password created by the user and communicated by the user to the security server.

5. The method according to claim 2, wherein, to register the user identification link with the security server, the actuating device provides the security server with the user identification data, the server returns a message to the actuating device designating the registration (OTP), which the actuating device sends to the user, and the user sends the registration back to the security server in an SMS message, through which the server learns the number of the portable terminal.

6. The method according to claim 2, wherein verification of identity and authenticity of a requester, when the requester asks the actuating device to perform an action, takes place in a dialog between the security server, the actuating device, and the user acting through the portable terminal.

7. The method according to claim 6, including allowing the dialog when an action is requested, downloading from the security server, into the portable terminal, during registration of the identification and authentication links, a Applet that includes software and data necessary for the dialog.

8. The method according to claim 6, wherein
the dialog, when the user submits a request for an action from the actuating device, includes
the actuating device sending the user identification data to the security server and indicating nature of the request, and
the security server sending to the portable terminal data indicating nature of the action requested, and
the user, using his portable terminal, sends confidential authentication data to the security server, which authorizes the actuating device to perform the action requested if the security server recognizes that the confidential authentication data received complies with the confidential authentication data recorded.
